(19) United States
(12) Patent Application Publication
(10) Pub. No.: US 2007/0261912 A1
(43) Pub. Date: Nov. 15, 2007

(54) Integrated audio speaker surround

(75) Inventor: Eric Aaron Langberg, Milford, PA (US)

Correspondence Address: Greenberg Traurig, LLP, 12th Floor, 1750 Tysons Boulevard, McLean, VA, 22102, US

(73) Assignee: Altec Lansing Technologies, Inc., Milford, PA (US)

(21) Appl. No.: 11/431,917

(22) Filed: May 11, 2006

(51) Int. Cl. H04R 7/00

(52) U.S. Cl. 181/171

(57) ABSTRACT

An audio speaker has a speaker surround integral with a covering or underlayer for the speaker housing. A flexible coating on the speaker housing, preferably a synthetic elastomer formed by an overmold process, at least partially covers an opening therein. A cone or other radiator may be attached to the coating in the region that it covers the opening leaving a portion of the coating to act as a speaker surround for the radiator, which may form an active or passive speaker driver.

### FIELD OF THE INVENTION

The present invention relates to consumer electronics having overmolded rubberized coverings, and more specifically, to integration of such exterior coverings with the speaker surround portion of an active or passive speaker driver.

### BACKGROUND OF THE INVENTION

A typical audio speaker has a housing or enclosure made of a relatively rigid material and one or more speaker drivers. Commonly, speaker housings are made from plastic or wood, but can also be formed from other materials including carbon fiber, metal and/or composites. Typically, the speaker housing is finished in an aesthetically pleasing manner, for example, wooden speaker cabinets are often given any one of a variety of wood finishes. The finish for plastics are often formed from the mold. Further finishing is sometimes provided, which finishing may be provided for aesthetic purposes. An opening in the housing is provided to permit radiation of sound from the speaker drivers. To protect the speaker drivers, in addition to finishing, speaker housings are frequently fitted with grilles.

In recent years, a rubberized overmolding has become more commonplace for finishing consumer goods, including consumer electronics, such as systems incorporating speakers. (The term “rubber” or “rubberized” is used herein to refer generally to any of a variety of natural or synthetic elastomers.) For example, the in Motion portable speaker system iM4 by Altec Lansing Technologies, Inc. of Milford, Pa. comprises such an overmolding. The overmolding may provide durability, grippiness and a small amount of shock absorption, but is principally provided for its aesthetically pleasing look and feel. The rubber overmolding may improve the acoustic features of a speaker housing when it is applied thereto.

The speaker driver itself generally comprises a frame that is mounted to the housing, a moveably mounted cone or diaphragm and a surround that attaches the cone to the frame in a manner that permits appropriate motion. Speaker drivers can be active or passive as is well known in the art. In the case of active drivers, an electromechanical system for driving the speaker diaphragm is also necessary.

In manufacturing the speaker driver, the surround is attached to the diaphragm and the frame. In making the audio speaker, the frame is then mounted to the enclosure.

What is needed is a speaker and enclosure that overcomes the disadvantages of the prior art.

### SUMMARY OF THE INVENTION

It is an object of the present invention to overcome the disadvantages of the prior art speakers.

It is an object of the present invention to provide an audio speaker with an integrated surround.

In an embodiment, an audio speaker is provided having a speaker enclosure with an opening therein, a radiator that fits within the opening in the speaker housing, a flexible coating having a housing portion, a surround portion and a radiator portion, the housing portion of the flexible coating being affixed to at least a portion of the speaker housing, the radiator portion being affixed to at least a portion of the radiator; and the surround portion providing a moveable attachment of the radiator to the housing.

In an embodiment, an audio speaker is providing comprising a speaker enclosure having an opening therein; a flexible coating having a housing portion and an opening portion; the housing portion of the flexible coating being affixed to at least a portion of the speaker housing such that the opening portion of the flexible coating covers the opening;

In an embodiment, a method for making an audio speaker is provided, the method comprising the steps of: forming an opening in a speaker housing, the opening having an interior edge; overmolding a flexible coating on at least a portion of a surface of the speaker housing, the flexible coating covering the opening; and affixing a radiator to the flexible coating.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1A is a cross-sectional view of an integrated speaker surround for a passive radiator in accordance with an embodiment of the invention.

FIGS. 1B-1, 1B-2, 1B-3, 1B-4 and 1B-5 are detail cross-sectional views of different shapes of speaker surrounds, in accordance with alternate embodiments of the invention.

FIG. 2 shows the integrated cover and speaker surround of FIG. 1A, as viewed from the interior of the speaker housing.

FIG. 3 is a cross-sectional view of an integrated speaker surround for a passive radiator in accordance with another embodiment of the invention.

FIG. 4 shows the integrated cover and speaker surround of FIG. 3, as viewed from the exterior of the speaker housing, where the stiffener has a circular shape in accordance with an embodiment of the invention.

FIG. 5 shows the integrated cover and speaker surround of FIG. 3, as viewed from the exterior of the speaker housing, where the stiffener has a rectangular shape in accordance with another embodiment of the invention.

FIG. 6 is an external view of an integrated overmolded cover and speaker surround in which the overmold has cutaway shapes, in accordance with a further embodiment of the invention.

FIG. 7A is a cross-sectional view of an integrated cover and speaker surround for a cone of an active speaker driver or passive radiator, in accordance with another embodiment of the invention.

FIGS. 7B and 7C are cross-sectional views of an integrated cover and speaker surround with an overmold bonded to a cone shape, in accordance with another embodiment of the invention.

FIG. 8 is a cross-sectional view of an integrated cover and speaker surround providing a waterproof/dustproof seal for an active speaker driver or passive radiator, in accordance with another embodiment of the invention.

FIGS. 9A and 9B are cross-sectional views of a speaker including a radiator and a frame, and a spider affixed to the frame movably supporting the radiator.

### DETAILED DESCRIPTION

Reference will now be made in detail to embodiments of the present invention, examples of which are illustrated in the accompanying drawings.

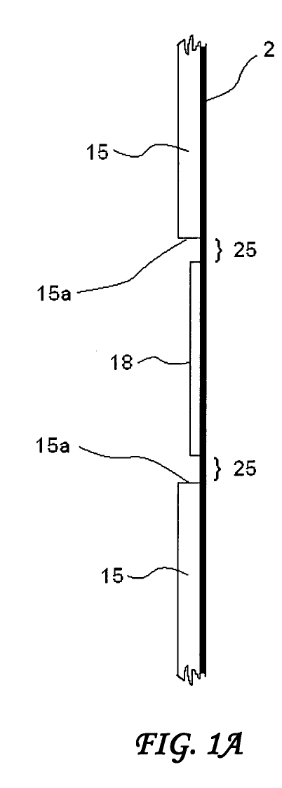

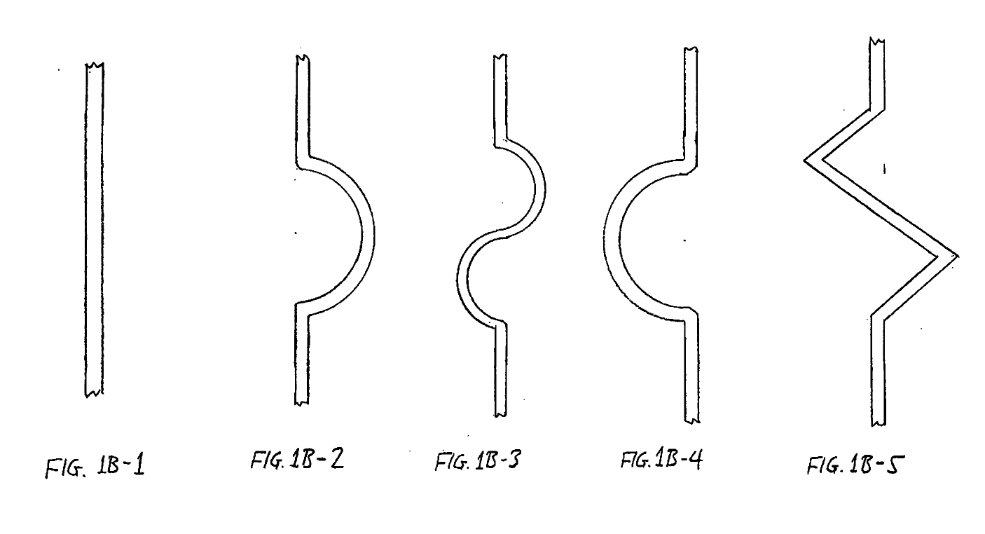

Turning first to FIG. 1A, a cross-sectional illustration of a passive radiator according to an embodiment of the invention is shown. Continuous rubber overmold 2 is secured to an exterior of the wall 15 of a speaker enclosure. The rubber overmold bridges an opening in the wall 15. A stiffener 18 is secured to the overmold 2, leaving regions 25 of the overmold 2 unsupported by the stiffener or by the wall 15. The wall 15 and the stiffener 18 may be formed together in the same molding process, using techniques known in the art.

As is well known in the art, a passive radiator may be flat, conic, concave, convex, or any other shape that can move air desirably in response to pressure within the speaker enclosure. In an embodiment, the stiffener 18 is rigid relative to the characteristics of the overmold 2.

In an embodiment, the materials for overmold 2 and wall 15 are selected so that they fuse together during the molding process (and likewise the materials for overmold 2 and stiffener 18). Accordingly, the overmold 2 may be bonded directly to the wall 15 of the speaker enclosure and to the stiffener 18. Stiffener 18 may have a flat profile as shown in FIG. 1A; alternatively, stiffener 18 may advantageously have a different profile, e.g. a cone shape as discussed in more detail below.

In an embodiment, the overmold 2 is adhered to the wall 15 by an adhesive such as glue, epoxy or cement. In an embodiment, the overmold 2 fastened to the wall 15 using fasteners such as nails, screws or rivets. In an embodiment, the overmold 2 may be affixed to the wall 15 using a plurality of means, including, for example, adhesive and fasteners. The overmold 2 may be affixed to the radiator in a similar or different manner.

In a region 25 adjacent the edge 15a of the opening, the rubber is unsupported and forms a speaker surround. This speaker surround may have a flat profile, as shown in FIG. 1A and in detail view in FIG. 1B-1. Alternatively, the speaker surround profile may be convex, an “S” curve, concave or a zigzag shape, as shown in FIGS. 1B-2, 1B-3, 1B-4 and 1B-5 respectively, or some other shape to be aesthetically pleasing and/or to assist the motion of the radiating surface.

Stiffener 18, affixed to the overmold 2, forms a mass region surrounded by the surround. This combination of the surround and mass region may be used to form a passive radiator. In an embodiment (not shown), a passive radiator may be formed without a stiffener, but rather by leaving the overmold 2 uncovered, and thus permitting the entire region between the edges of the walls 15a to move in response to changes in pressure in the speaker enclosure.

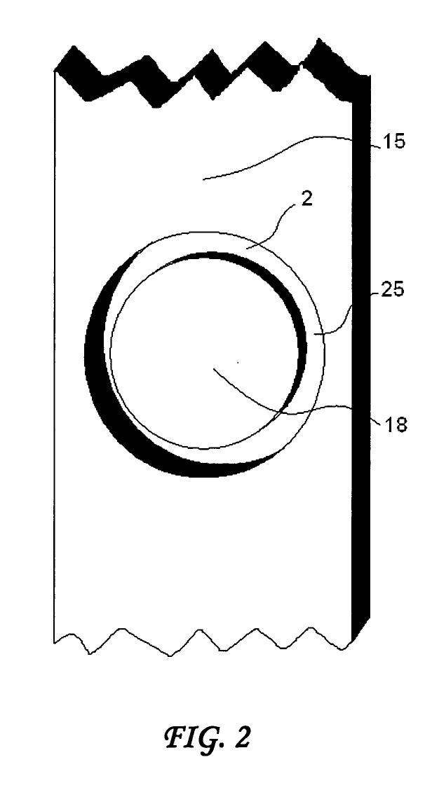

FIG. 2 is another view of the integrated speaker and surround shown in FIG. 1A. An annular region 25 of rubber has a generally circular stiffener 18 substantially centered therein, so that region 25 and stiffener 18 together comprise a circular integrated passive radiator.

As illustrated, the opening in the wall 15 can be circular. In an embodiment, other shapes of openings in wall 15 may be used. The shape of stiffener 18 likewise need not be round, and in an embodiment, is configured to permit adequate operation of the surround and to accommodate the shape of opening in wall 15 formed by the edges 15a.

The stiffener 18 may, but need not be, formed from the same material as the wall 15. Moreover, the stiffener 18 may, but need not be, substantially thinner or thicker than the thickness of the wall 15.

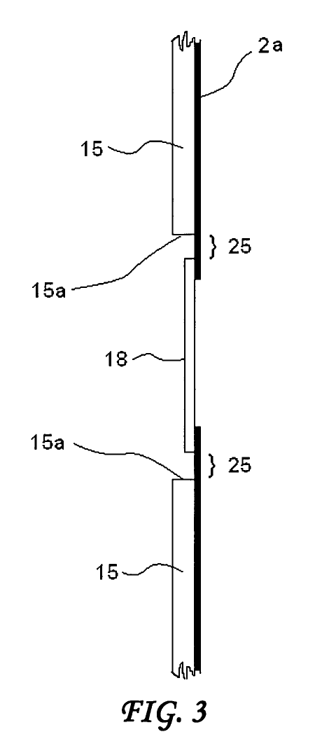

Turning next to FIG. 3, a cross-sectional illustration of a passive radiator according to an embodiment of the invention is shown. As in FIG. 1A, rubber overmold 2a is secured to an exterior of the wall 15 of a speaker enclosure is shown. In an embodiment, the rubber overmold bridges part of the opening in the wall 15. A stiffener 18 is secured to at least a portion of the overmold 2a, leaving regions 25 of the overmold 2s unsupported by the stiffener or by the wall 15. In an embodiment, the stiffener 18 is rigid relative to the characteristics of the overmold 2a.

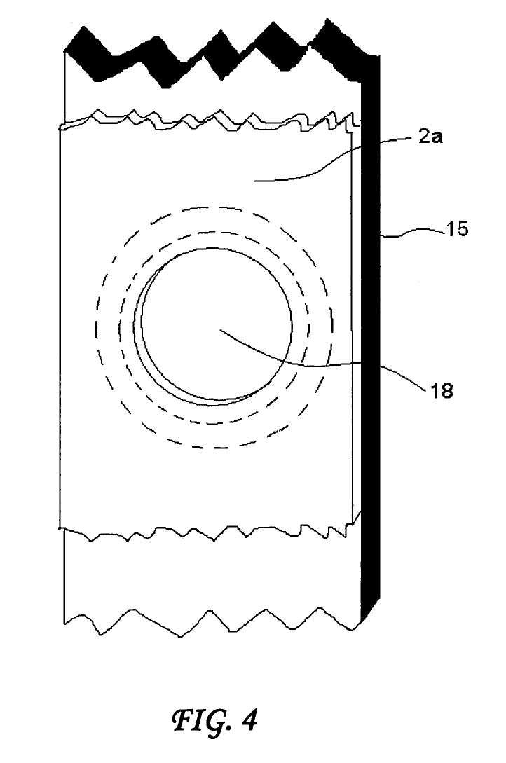

FIG. 4 shows an external view of the cross-sectional illustration of FIG. 3. The overmold 2 extends beyond the edge 15a of wall 15 (shown in phantom), and into the circumference (also shown in phantom) of stiffener 18.

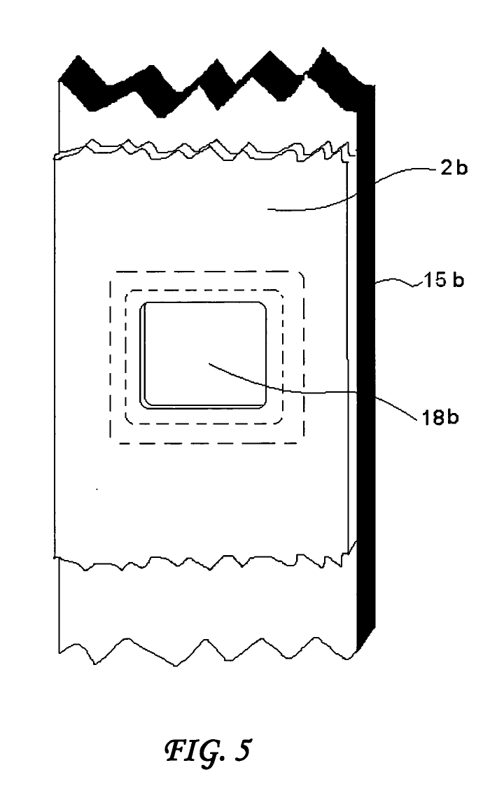

In an embodiment, for example, intending to illustrate but not to limit the types the opening in the wall 15 and the stiffener 18 that may be used, such opening and stiffener may be substantially in the shape of a rounded rectangle, a pentagon, a hexagon or an oval. In an embodiment, the shape of the opening in the wall 15 and/or the stiffener 18 are an irregular shape. Turning now to FIG. 5, an external view of an embodiment of the present invention is shown. The overmold 2b extends beyond the edge of the rounded rectangular cutout (shown in phantom) in wall 15b, and into the perimeter (also shown in phantom) of stiffener 18b. The overmold 2b is affixed to wall 15b. Portions of stiffener 18b are affixed to the overmold 2b, thereby movably supporting stiffener 18b.

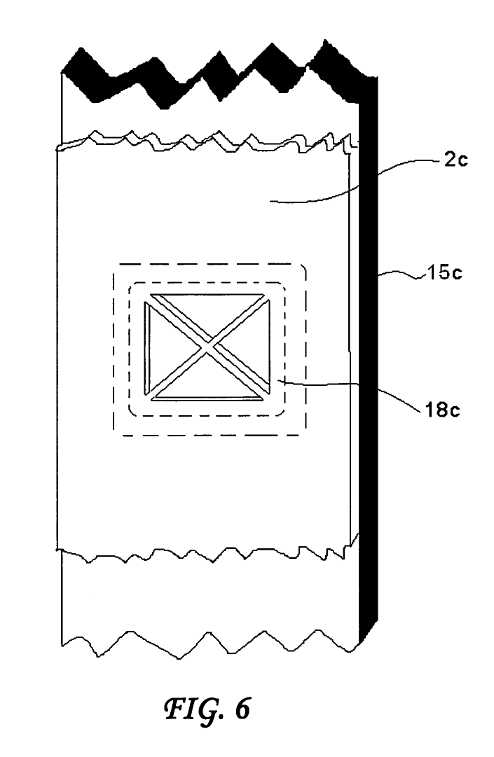

Turning now to FIG. 6, in an embodiment, the overmold 2c may have cutaway shapes in an area that otherwise would be affixed to the stiffener 18c or the wall 15 of a speaker enclosure. In an embodiment, as illustrated in FIG. 6, such cutaway shapes may provide straps to permit the stiffener 18c to be securely affixed to, and supported by the overmold 2c, or for decorative and/or aesthetic purposes. It will be apparent to one of skill in the art that cutaways can be provided to, for example, without intending to limit the generality of the invention, illustrate trademarks, logos or company names. Such illustrations can be cut away from the overmold 2c where it would otherwise be affixed to the wall 15c, the stiffener 18c or as a combination of both.

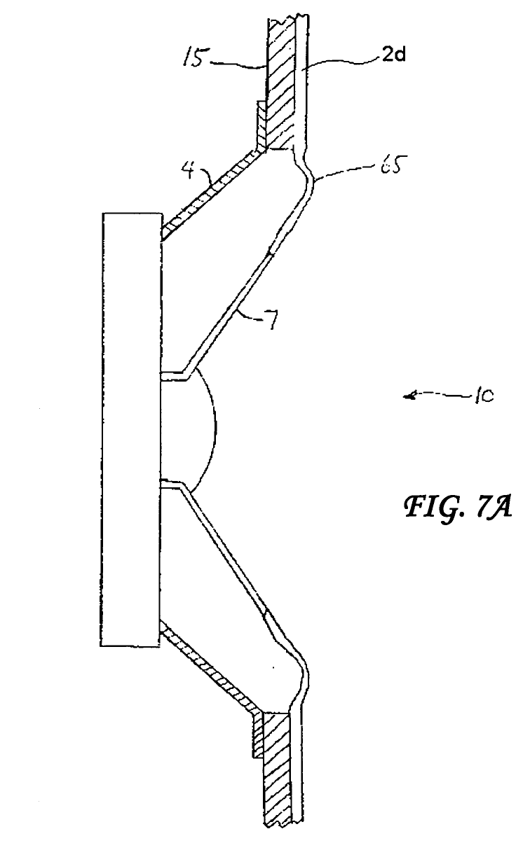

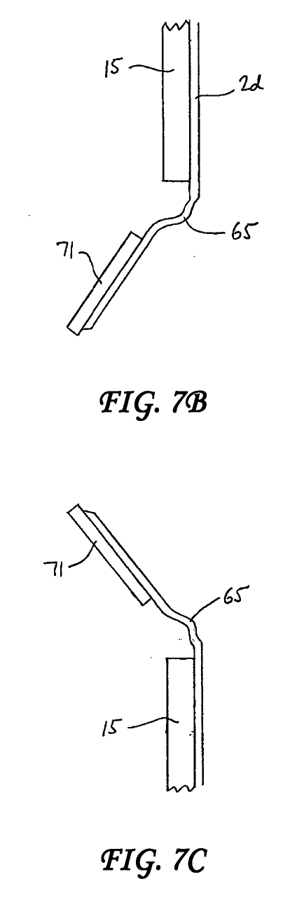

Turning to FIG. 7A, an embodiment of the present invention is shown in which an active speaker driver or conic passive radiator is formed using the integrated surround. Active speaker driver 10 comprises a frame 4 and a cone 7. The frame 4 is affixed to the wall 15 of the speaker cabinet. The frame 4 may be affixed to the wall by adhesives and/or fasteners, or by welding, bonding or other fastening methods, and may be separated from the wall 15 by a gasket (not shown). The cone 7 is supported by surround 65 formed from the overmold 2d. In an embodiment, the overmold 2d may, but need not be, thinned and shaped in the area forming the surround 65. In an embodiment, the overmold 2d is affixed to the cone 7 using an adhesive. In an embodiment, the cone 7 is made of material that bonds with the surround during the overmold process. In an embodiment, the cone 7 is affixed to the overmold 2d using a heat process. In an embodiment, the cone 7 is affixed to the overmold 2d by a welding process. In an embodiment, the cone 7 is affixed to the overmold 2d using fasteners such as nails, screws or rivets. In an embodiment, the cone 7 is affixed to the overmold 2d using a plurality of means, including, for example, adhesive and fasteners.

In an embodiment, the speaker is made by affixing a preassembly of the frame 4 and the cone 7 to the speaker enclosure wall 15. Once it is affixed, the cone 7 is thereafter affixed to the surround 65. The overmold 2d (including the surround 65) may be affixed to the wall 15 before, after or at the same time that it is affixed to the cone 7. In an embodiment, the speaker is made by affixing the cone to the surround 65 before it is assembled with the frame 4.

As noted above, a cone 71 may be formed in the same molding process used to form the wall 15 of the speaker enclosure (shown in cross-section in FIGS. 7B and 7C). Accordingly, the overmold process may cover the exterior surface of cone 71, thereby forming surround 65. The frame and other components may then be attached to cone 71 to form a speaker driver or passive radiator as shown in FIG. 7A. It will be appreciated that the speaker driver may be formed with or without a conventional spider or damper, depending on the size and nature of the driver being formed.

In another embodiment, the wall 15 of the speaker enclosure and stiffener 18 are formed (and may advantageously be formed in the same molding process); overmold 2d is then affixed to (or overmolded to fuse or adhere to) both wall 15 and stiffener 18, thereby forming surround 65 and sealing the opening in wall 15. The overmold 2d thus isolates the interior of the speaker enclosure from the exterior. Accordingly, the cone 72 of speaker driver 11 may be fixed to the interior surface of stiffener 18 without the need for a conventional dust cap.

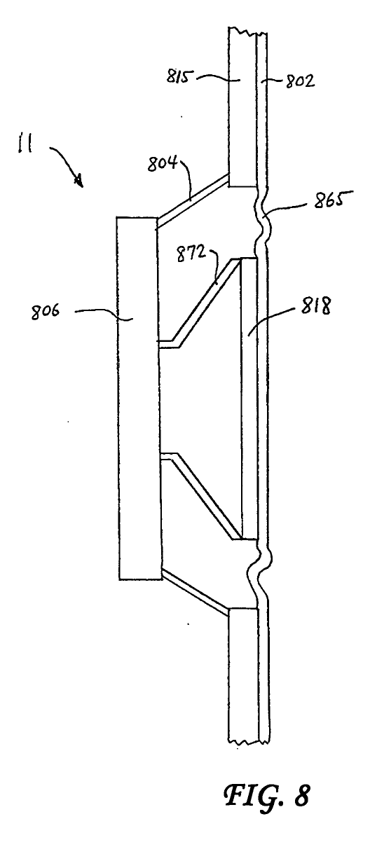

In an embodiment, walls 815 are molded in one molding step. Where stiffener 818 is made from the same material as walls 815, it may be molded in the same molding step in which walls 815 are molded, or in a previous of subsequent molding step. Where stiffener 818 us made from differing materials from walls 815, it may be molded in a previous or subsequent molding step. Once the walls 815 and stiffener 818 are molded, the mold is opened and a new mold cover is used for an overlay molding step. The overmold 802 (including the surround 865) may be molded in the second molding step. As is known in the art, where appropriate materials are selected, overmold 802 will be affixed to walls 815 and stiffener 818, without the need for adhesives or fasteners. A driving member 872 may thereafter be welded or otherwise affixed to stiffener 818. The driving member 872 may be any shape; for example, without intending to limit the scope of the invention, in an embodiment, the driving member may be a cone or a pyramid. A frame 804 supports magnet assembly 806. The overmold permits formation of a sealed speaker system (see FIG. 8) that is both dustproof and waterproof. There is therefore no need to first seal the speaker driver and then seal the driver frame to the cabinet, as in conventional waterproof speaker systems.

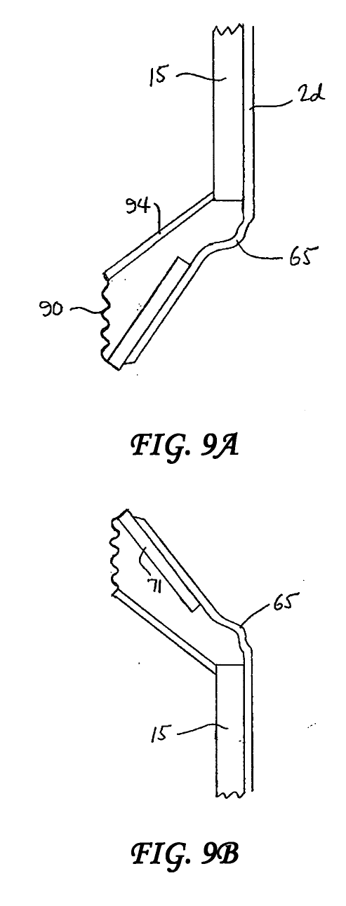

A speaker constructed according to any of the above-described embodiments may also include a spider affixed to the frame and movably supporting the radiator, as shown schematically in FIGS. 9A and 9B. In these Figures, spider 90 is affixed to frame 94 (which in turn is attached to housing 15) and supports radiator cone 71. The spider may be used to adjust the stiffness of the spring formed by the radiator and the surround 65, without adding mass to the radiator.

In the foregoing descriptions, the rubber overmold 2 is disposed on the outside of the speaker housing. It will be appreciated that the overmold could alternatively be located on the interior of the housing. Similarly, a stiffener can be located outside of the overmold instead of, or in addition to, being located inside the overmold.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. An audio speaker comprising:
a speaker housing having an opening therein;
a radiator that fits within the opening in the speaker housing;
a flexible coating having a housing portion, a surround portion and a radiator portion;
the housing portion of the flexible coating being affixed to at least a portion of the speaker housing;
the radiator portion being affixed to at least a portion of the radiator; and
the surround portion providing a movable attachment of the radiator to the housing.

2. The audio speaker claimed in claim 1, wherein at least part of the surround portion has a reduced thickness compared to the housing portion.

3. The audio speaker claimed in claim 1, wherein the opening is substantially circular.

4. The audio speaker claimed in claim 3, wherein the radiator is conically shaped.

5. The audio speaker claimed in claim 3, wherein the radiator is flat.

6. The audio speaker claimed in claim 4, additionally comprising a frame affixed to the housing.

7. The audio speaker claimed in claim 6, further comprising a spider affixed to the frame and movably supporting the radiator.

8. The audio speaker claimed in claim 6, additionally comprising a magnet affixed to the frame and a voice coil affixed to the radiator.

9. The audio speaker claimed in claim 1, wherein the housing portion of the flexible coating is affixed to at least a portion of the exterior of the speaker housing.

10. The audio speaker claimed in claim 1, wherein the speaker housing has a face, and the housing portion of the flexible coating is affixed to the face of the speaker housing.

11. The audio speaker claimed in claim 1, wherein the housing portion of the flexible coating is affixed to at least a portion of the interior of the speaker housing.

12. The audio speaker claimed in claim 1, wherein the flexible coating comprises a synthetic elastomer.

13. The audio speaker claimed in claim 1, wherein the flexible coating is effective to provide dustproofing for the opening.

14. The audio speaker claimed in claim 1, wherein the flexible coating is effective to provide waterproofing for the opening.

15. An audio speaker comprising:
a speaker housing having an opening therein; and
a flexible coating having a housing portion and an opening portion;
the housing portion of the flexible coating being affixed to at least a portion of the speaker housing such that the opening portion of the flexible coating covers the opening.

16. The audio speaker claimed in claim 15, wherein the opening is substantially circular.

17. The audio speaker claimed in claim 15, wherein the opening has an edge, the audio speaker additionally comprising a radiator having an outer perimeter affixed to a portion of the opening portion in a manner leaving a substantially uniform portion of the flexible coating between the outer perimeter and the edge of the opening.

18. The audio speaker claimed in claim 15, wherein the housing portion of the flexible coating is affixed to at least a portion of the exterior of the speaker housing.

19. The audio speaker claimed in claim 15, wherein the speaker housing has a face, and the housing portion of the flexible coating is affixed to the face of the speaker housing.

20. The audio speaker claimed in claim 15, wherein the housing portion of the flexible coating is affixed to at least a portion of the interior of the speaker housing.

21. The audio speaker claimed in claim 15, wherein the flexible coating comprises a synthetic elastomer.

22. The audio speaker claimed in claim 15, wherein the flexible coating is effective to provide a dustproof seal for the opening.

23. The audio speaker claimed in claim 15, wherein the flexible coating is effective to provide a waterproof seal for the opening.

24. A method for making an audio speaker, the method comprising the steps of:
forming a speaker housing with at least one opening;
overmolding a flexible coating on at least a portion of a surface of the speaker housing, the flexible coating covering at least one of the at least one openings; and
affixing a radiator to the flexible coating.

25. The method claimed in claim 24, wherein the flexible coating is a synthetic elastomer.

26. The method claimed in claim 24, wherein the radiator is substantially flat and forms a stiffener in contact with at least a portion of the flexible coating within the opening.

27. The method claimed in claim 24, wherein the speaker housing and the radiator are formed in a same molding process.

28. The method claimed in claim 24, wherein the radiator is pyramidally shaped.

29. The method claimed in claim 24, wherein the radiator is conically shaped.

30. A method for making an audio speaker, the method comprising the steps of:
forming a speaker housing with at least one opening;
overmolding a flexible coating on at least a portion of a surface of the speaker housing, the flexible coating covering at least one of the at least one openings;
affixing together a stiffener and the flexible coating;
affixing a driving member to the stiffener, whereby the flexible coating seals the at least one of the at least one openings.

31. The method claimed in claim 30, further comprising the step of forming a stiffener, wherein the speaker housing and the stiffener are formed in a same molding process.

32. The method claimed in claim 30, wherein the flexible coating is effective to provide a dustproof seal for the opening.

33. The method claimed in claim 30, wherein the flexible coating is effective to provide a waterproof seal for the opening.

34. The method claimed in claim 30, wherein the step of affixing together the stiffener and the flexible coating is performed as part of the step of overmolding.

35. A method for making an audio speaker, the method comprising the steps of:
molding a wall of a speaker housing having an opening therein and molding a stiffener within the opening, wherein a gap exists between the wall and the stiffener; and
overmolding a flexible coating on at least a portion of the wall and on at least a portion of the stiffener, whereby the flexible coating covers the gap, thereby causing the flexible coating to flexibly affix the stiffener to the walls.

36. The method claimed in claim 35, further comprising the step of operatively affixing a voice coil to the stiffener.

37. The method claimed in claim 36, further comprising the step of affixing a frame to the wall, wherein the frame supports a magnet assembly in operative proximity to the voice coil.

38. The method claimed in claim 35, wherein the wall, stiffener and flexible coating are of materials such that the flexible coating adheres to the wall and to the stiffener without adhesives or fasteners.

39. The method claimed in claim 35, wherein the flexible coating is effective to provide a dustproof seal for the opening.

40. The method claimed in claim 35, wherein the flexible coating is effective to provide a waterproof seal for the opening.

41. The method claimed in claim 36, wherein the step of molding includes molding a frame integral to the wall, and the method further comprises the step of affixing a magnet assembly to the frame such that the magnet assembly is in operative proximity to the voice coil.
